(19) United States
(12) Patent Application Publication
(10) Pub. No.: US 2025/0083697 A1
(43) Pub. Date: Mar. 13, 2025

(54) APPARATUS FOR CONTROLLING VEHICLE AND METHOD THEREOF

(71) Applicants: Hyundai Motor Company, Seoul (KR); Kia Corporation, Seoul (KR); Hyundai Mobis Co., LTD., Seoul (KR)

(72) Inventors: Ju Hyeok RA, Guri-Si (KR); Young Joo Kim, Young-Si (KR)

(21) Appl. No.: 18/655,807

(22) Filed: May 6, 2024

(30) Foreign Application Priority Data
Sep. 11, 2023 (KR) 10-2023-0120572

(51) Int. Cl. B60W 60/00; G06V 20/58

(52) U.S. Cl. CPC B60W 60/001; G06V 20/58; B60W 2520/10; B60W 2520/14; B60W 2554/805

(57) ABSTRACT

An apparatus for controlling a vehicle is introduced. The apparatus may comprise a sensor and a processor configured to determine different virtual boxes corresponding to objects detected by the sensor at different times, convert a first set of points included in first virtual boxes to a second set of points, generate, based on the convert, a plurality of clusters, adjust, based on the clusters, another set of points included in other virtual boxes, determine, based on the adjusted set of points, the other virtual boxes as a road edge, and output, based on the road edge, a signal to control the vehicle.

### CROSS-REFERENCE TO RELATED APPLICATION

This application claims the benefit of priority to Korean Patent Application No. 10-2023-0120572, filed in the Korean Intellectual Property Office on Sep. 11, 2023, the entire contents of which are incorporated herein by reference.

### TECHNICAL FIELD

The present disclosure relates to an apparatus for controlling a vehicle control apparatus and a method thereof, and more specifically, relates to a technology for determining an external object by using a sensor (e.g., light detection and ranging (LiDAR)).

### BACKGROUND

Various studies are being conducted to identify an external object by using various sensors to assist a host vehicle in driving.

In particular, while the host vehicle is driving in a driving assistance device activation mode or an autonomous driving mode, the external object may be identified by using a sensor (e.g., LiDAR).

If a road edge is incorrectly identified by using the LiDAR, an external vehicle driving on a road may be identified as a stationary object outside the road, or may be identified as a moving object due to occlusion of the road edge. If the external vehicle is identified as the stationary object outside the road, or as the moving object due to the occlusion of the road edge, the driving route of the host vehicle may change suddenly.

### SUMMARY

According to the present disclosure, an apparatus for controlling a vehicle, the apparatus may comprise a processor, and a sensor, wherein the processor is configured to at a first time point, determine first virtual boxes corresponding to objects detected by the sensor, wherein the objects are external to the vehicle, and the first virtual boxes comprise a plurality of first points, at a second time point after the first time point, convert the plurality of first points into a plurality of second points while the vehicle is driving and determine second virtual boxes corresponding to the objects detected at the second time point, wherein the second virtual boxes comprise a plurality of fifth points, perform, based on the converting, clustering on the plurality of second points to generate a plurality of clusters may comprise a first cluster and a second cluster, generate a third cluster obtained by merging the first cluster and the second cluster based on at least one of slope information or distance information which is obtained by the first cluster and the second cluster, determine a direction, in which the third cluster is located relative to the vehicle, based on at least one of an intermediate value of a plurality of third points included in the third cluster, or a minimum value of the plurality of third points, adjust the plurality of fifth points based on a plurality of fourth points obtained by sampling the plurality of third points at an interval, determine, based on the adjusted plurality of fifth points, the second virtual boxes as a road edge, and output, based on the road edge, a signal to control the vehicle.

The apparatus, wherein the processor is configured to generate the third cluster by obtaining the slope information based on at least one of a first slope by a first minimum value and a first maximum value, which are included in the first cluster, or a second slope by a second minimum value and a second maximum value, which are included in the second cluster, merging the first cluster and the second cluster based on an angle between the first slope and the second slope, wherein the second slope is smaller than or equal to a threshold angle.

The apparatus, wherein the processor is configured to generate the third cluster by obtaining the distance information based on at least one of a distance between the first minimum value and the second maximum value, or a distance between the second minimum value and the first maximum value, merging the first cluster and the second cluster, based on at least one of the distance between the first minimum value and the second maximum value, or the distance between the second minimum value and the first maximum value, wherein the first maximum value is smaller than or equal to a specified distance.

The apparatus, wherein a type of the objects specified at the first time point may comprise a first type in which the objects are in a stationary state, a second type in which the objects are in a movement state, and a third type in which the objects are not in either the stationary state or the movement state.

The apparatus, wherein the vehicle is driven at a speed of a first section, the processor is configured to determine the direction, in which the third cluster is located relative to the vehicle, based on at least one of a wheel space of the vehicle, a steering angle of the vehicle, a speed of the vehicle, or a yaw rate of the vehicle, and wherein the vehicle is driven at a speed exceeding the speed of the first section, the processor is configured to determine the direction, in which the third cluster is located relative to the vehicle, based on at least one of the yaw rate of the vehicle, or the speed of the vehicle.

The apparatus, wherein the processor is configured to determine differences between the plurality of fourth points stored in a first region and the plurality of fifth points, which are stored in a second region and which respectively correspond to the plurality of fourth points, and adjust each of the plurality of fifth points based on an average of the determined differences.

The apparatus, wherein the processor is configured to convert the plurality of first points, determined at the first time point, to the plurality of second points at the second time point based on information related to driving of the vehicle. The apparatus, wherein the information related to the driving of the vehicle includes at least one of a speed of the vehicle, a yaw rate of the vehicle, or a time interval at which a plurality of points are obtained by the sensor.

The apparatus, wherein the processor is configured to generate the third cluster by merging the first cluster and the second cluster, based on the first cluster including a plurality of points of which a number is greater than or equal to a reference number, and the second cluster including a plurality of points of which a number is greater than or equal to the reference number.

The apparatus, wherein the processor is configured to generate the third cluster by merging the first cluster and the second cluster, based on a length of the first cluster being greater than or equal to a reference length, and a length of the second cluster being greater than or equal to the reference length. The apparatus, wherein the processor is configured to generate the third cluster by merging the first cluster and the second cluster, based on determining that the first cluster and the second cluster are within a reference distance based on a lateral direction of the vehicle.

According to the present disclosure, a method for controlling a vehicle, the method may comprise at a first time point, determining first virtual boxes corresponding to objects detected by a sensor, wherein the objects are external to the vehicle, and the first virtual boxes comprise a plurality of first points, at a second time point after the first time point, converting the plurality of first points into a plurality of second points while the vehicle is driving and determining second virtual boxes corresponding to the objects detected at the second time point, wherein the second virtual boxes comprise a plurality of fifth points, performing, based on the converting, clustering on the plurality of second points to generate a plurality of clusters may comprise a first cluster and a second cluster, generating a third cluster obtained by merging the first cluster and the second cluster based on at least one of slope information or distance information, which is obtained by the first cluster and the second cluster, determining a direction, in which the third cluster is located relative to the vehicle, based on at least one of an intermediate value of a plurality of third points included in the third cluster, or a minimum value of the plurality of third points, adjusting a plurality of fifth points based on a plurality of fourth points obtained by sampling the plurality of third points at an interval, determining, based on the adjusting, the second virtual boxes as a road edge, and outputting, based on the road edge, a signal to control the vehicle.

The method, wherein the generating the third cluster may comprise obtaining the slope information based on at least one of a first slope by a first minimum value and a first maximum value, which are included in the first cluster, or a second slope by a second minimum value and a second maximum value, which are included in the second cluster, merging the first cluster and the second cluster, based on an angle between the first slope and the second slope, wherein the second slope is smaller than or equal to a specified angle.

The method, wherein the generating the third cluster may comprise obtaining the distance information based on at least one of a distance between the first minimum value and the second maximum value, or a distance between the second minimum value and the first maximum value, merging the first cluster and the second cluster, based on at least one of the distance between the first minimum value and the second maximum value, or the distance between the second minimum value and the first maximum value, wherein the first maximum value is smaller than or equal to a threshold distance.

The method, wherein a type of the objects specified at the first time point may comprise a first type in which the objects are in a stationary state, a second type in which the objects are in a movement state, and a third type in which the objects are not in either the stationary state or the movement state.

The method, wherein the vehicle is driven at a speed of a first section, may further comprise determining the direction, in which the third cluster is located relative to the vehicle, based on at least one of a wheel space of the vehicle, a steering angle of the vehicle, a speed of the vehicle, or a yaw rate of the vehicle, and wherein the vehicle is driven at a speed exceeding the speed of the first section, may further comprise determining the direction, in which the third cluster is located relative to the vehicle, based on at least one of the yaw rate of the vehicle, or the speed of the vehicle.

The method, further may comprise determining differences between the plurality of fourth points stored in a first region and the plurality of fifth points, which are stored in a second region and which respectively correspond to the plurality of fourth points, and adjusting each of the plurality of fifth points based on an average of the determined differences. The method, wherein converting the plurality of first points is based on information related to driving of the vehicle.

The method, wherein the information related to the driving of the vehicle includes at least one of a speed of the vehicle, a yaw rate of the vehicle, or a time interval at which a plurality of points are obtained by the sensor. The method, wherein the generating the third cluster may comprise merging the first cluster and the second cluster, based on the first cluster including a plurality of points of which a number is greater than or equal to a reference number, and the second cluster including a plurality of points of which a number is greater than or equal to the reference number.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram of a vehicle control apparatus, according to an example of the present disclosure;

FIG. 2 shows an example in which a vehicle control apparatus performs clustering, according to an example of the present disclosure;

FIG. 3 shows an example in which a vehicle control apparatus identifies a road edge, according to an example of the present disclosure;

FIG. 4 shows an example of a flowchart related to a vehicle control method, according to an example of the present disclosure;

FIG. 5 shows an example of the result obtained as a vehicle control apparatus corrects a plurality of points, according to an example of the present disclosure;

FIG. 6 shows an example of the result obtained as a vehicle control apparatus corrects a plurality of points, according to an example of the present disclosure; and

FIG. 7 shows an example of a computing system including a vehicle control apparatus, according to an example of the present disclosure.

### DETAILED DESCRIPTION

Hereinafter, some examples of the present disclosure will be described in detail with reference to the accompanying drawings. In adding reference numerals to components of each drawing, it should be noted that the same components have the same reference numerals, although they are indicated on another drawing. Furthermore, in describing the examples of the present disclosure, detailed descriptions associated with well-known functions or configurations will be omitted when they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning that is consistent with their meaning in the context of the present disclosure and the relevant art and will not be interpreted in an idealized or overly formal sense unless expressly so defined herein.

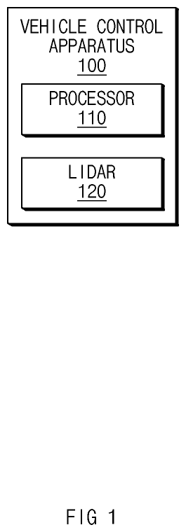

Hereinafter, various examples of the present disclosure will be described in detail with reference to FIGS. 1 to 7.

FIG. 1 shows an example of a block diagram of a vehicle control apparatus, according to an example of the present disclosure.

Referring to FIG. 1, a vehicle control apparatus 100 according to an example of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be connected to control units of the vehicle by means of a separate connection means. For example, the vehicle control apparatus 100 may further include components not shown in FIG. 1.

The vehicle control apparatus 100 according to an example may include a processor 110 and a LiDAR 120. The processor 110 or the LiDAR 120 may be electrically or operably connected to each other by an electronic component including a communication bus.

Hereinafter, the fact that pieces of hardware are coupled operably may include the fact that a direct or indirect connection between the pieces of hardware is established wired or wirelessly such that second hardware is controlled by first hardware among the pieces of hardware.

Although different blocks are shown, an example is not limited thereto. Some of the pieces of hardware in FIG. 1 may be included in a single integrated circuit including a system on a chip (SoC). The type or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an example may include hardware for processing data based on one or more instructions. The hardware for processing data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may have the structure of a single-core processor, or may have a structure of a multi-core processor including a dual core, a quad core, a hexa core, or an octa core.

In an example, the vehicle control apparatus 100 may include the LiDAR 120. For example, the LiDAR 120 may obtain data sets from identifying objects surrounding the vehicle control apparatus 100. For example, the LiDAR 120 may identify at least one of location of the surrounding object, a movement direction of the surrounding object, a speed of the surrounding object, or any combination thereof based on a pulse laser signal that is emitted from the LiDAR 120, reflected by the surrounding object, and returned.

While the host vehicle is driving, the processor 110 of the vehicle control apparatus 100 according to an example may identify external objects by using the LiDAR 120. For example, the processor 110 may identify types of external objects while the host vehicle is driving.

For example, the processor 110 may identify that external object is of a first type, based on identifying that the external object is in a stationary state. The processor 110 may identify that the external object is of a second type, based on identifying that the external object is in a movement state. The processor 110 may identify that the external object is of a third type, based on identifying that the external object is in a stationary or movement state.

In an example, while the host vehicle is driving, the processor 110 may convert a plurality of first points, which are included in first virtual boxes corresponding to external objects identified by the LiDAR as being of a specified type at a first time point, into a plurality of second points at a second time point after the first time point.

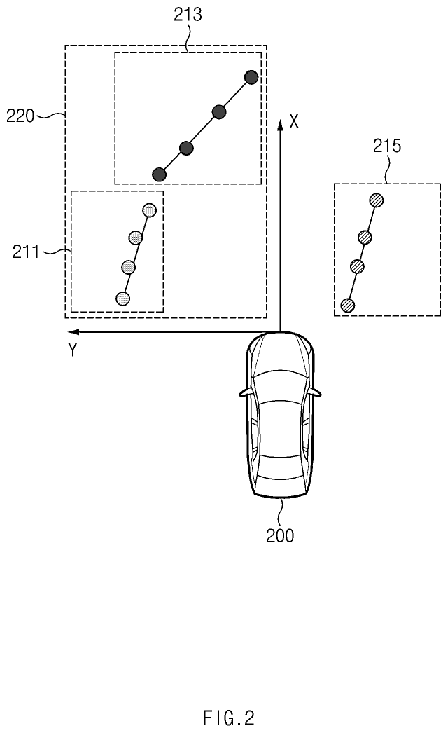

For example, the processor 110 may convert a plurality of first points into a plurality of second points by using time shift. For example, the processor 110 may convert the plurality of first points into the plurality of second points, by using equations included in FIG. 2, which will be described later.

In an example, the processor 110 may perform clustering on the plurality of second points at the second time point. For example, the processor 110 may perform clustering on the plurality of second points where a virtual box including the plurality of second points is identified as being in a stationary state, and the plurality of second points is located within a specified distance.

For example, the processor 110 may perform clustering on the plurality of second points based on the virtual box including the plurality of second points being classified as a road edge. For example, the processor 110 may perform clustering on the plurality of second points based on the fact that a length of the virtual box including the plurality of second points is greater than or equal to a specified length (e.g., 10 meters) and is identified as being in a stationary state. For example, the length of a virtual box may include a distance between a minimum value and a maximum value, which are included in the virtual box.

For example, the processor 110 may generate a plurality of clusters based on performing clustering on the plurality of second points. For example, the processor 110 may identify at least one of slope information, distance information, or any combination thereof by a first cluster and a second cluster among the plurality of clusters. The processor 110 may obtain one of the slope information, the distance information, or any combination thereof based on a plurality of points included in the first cluster and a plurality of points included in the second cluster.

For example, the processor 110 may identify a first minimum value and a first maximum value among the plurality of points included in the first cluster. For example, the processor 110 may identify the first minimum value and the first maximum value based on the x-coordinate of each of the plurality of points included in the first cluster. For example, the processor 110 may identify the first minimum value with the smallest x coordinate among the plurality of points included in the first cluster. For example, the processor 110 may identify the first maximum value with the greatest x coordinate among the plurality of points included in the first cluster.

For example, the processor 110 may identify a second minimum value and a second maximum value among the plurality of points included in the second cluster. For example, the processor 110 may identify the second minimum value and the second maximum value based on the x-coordinate of each of the plurality of points included in the second cluster. For example, the processor 110 may identify the second minimum value with the smallest x coordinate g the plurality of points included in the second cluster. For example, the processor 110 may identify the second maximum value with the greatest x coordinate among the plurality of points included in the second cluster.

In an example, the processor 110 may obtain a first slope based on the first minimum value and the first maximum value, which are identified in the first cluster. For example, the processor 110 may obtain the first slope based on coordinates of the first minimum value and coordinates of the first maximum value. For example, the processor 110 may obtain a second slope based on the second minimum value and the second maximum value, which are identified in the second cluster. For example, the processor 110 may obtain the second slope based on coordinates of the second minimum value and coordinates of the second maximum value. For example, the first slope may be included in first slope information related to the first cluster, and the second slope may be included in second slope information related to the second cluster.

For example, the first slope information may include information related to an angle formed by the y-axis and a straight line based on the first minimum value and first maximum value. For example, the second slope information may include information related to an angle formed by the y-axis and a straight line based on the second minimum value and second maximum value.

For example, the first slope information may include heading information indicating a heading direction of the first cluster. For example, the second slope information may include heading information indicating a heading direction of the second cluster.

In an example, the processor 110 may compare the first slope information with the second slope information. For example, the processor 110 may compare the first slope information with the second slope information and may generate a third cluster obtained by merging the first cluster and the second cluster. For example, the processor 110 may generate the third cluster from merging the first cluster and the second cluster based on the fact that the heading direction of the first cluster and the heading direction of the second cluster are identified as being within a specified angle (e.g., approximately 8 degrees).

In an example, the processor 110 may merge the first cluster and the second cluster based on the number of points included in at least one of the first cluster, the second cluster, or any combination thereof. For example, the processor 110 may merge the first cluster and the second cluster based on lengths of the clusters. For example, the processor 110 may merge the first cluster and the second cluster based on locations of the clusters.

For example, if the number of points is greater than or equal to the specified number (e.g., 3), the length of each cluster is greater than or equal to a specified length (e.g., 1.5 m), and each cluster is present within a specified distance (e.g., 7 lanes) from a host vehicle, the processor 110 may merge the first cluster and the second cluster. For example, the fact that each of the clusters is present within a specified lane from the host vehicle may include the fact that each of the clusters is present within about 24.5 m in a direction parallel to the side of the host vehicle.

In an example, the processor 110 may obtain the third cluster from merging the first cluster and the second cluster. The processor 110 may identify a plurality of third points included in the third cluster. The processor 110 may identify coordinates of the plurality of third points included in the third cluster. The processor 110 may identify at least one of an intermediate value of the plurality of third points, a minimum value of the plurality of third points, a maximum value of the plurality of third points, or any combination thereof. For example, the processor 110 may identify a third minimum value, which is the smallest x coordinate, from among the plurality of third points. For example, the processor 110 may identify a third maximum value, which is the greatest x coordinate, from among the plurality of third points. For example, the processor 110 may identify an intermediate value corresponding to the average of the third minimum value and the third maximum value. For example, the intermediate value may be referred to as a “mean point”.

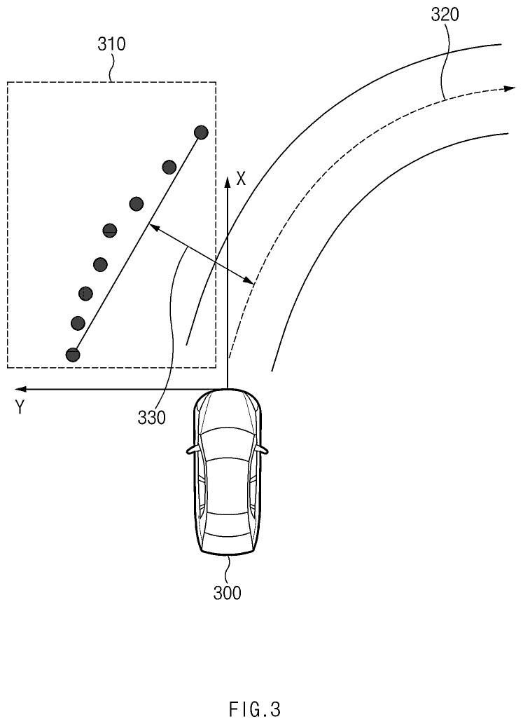

In an example, the processor 110 may identify a direction, in which the third cluster is located relative to the host vehicle, based on at least one of the intermediate value of a plurality of third points, which are included in the third cluster, the minimum value of the plurality of third points, the maximum value of the plurality of third points, or any combination thereof. For example, the processor 110 may determine whether the third cluster is located on the left side or right side of the host vehicle. For example, the processor 110 may identify a direction, in which the third cluster is located relative to the host vehicle, based on equations included in FIG. 3 described later. For example, the processor 110 may identify the direction, in which the third cluster is located relative to the host vehicle, based on the radius of curvature based on the host vehicle and the plurality of third points.

In an example, the processor 110 may sample the plurality of third points included in the third cluster. For example, the sampling may include quantization. For example, the quantization may include at least one of linear quantization, uniform quantization, non-linear quantization, adaptive quantization, fixed quantization, scalar quantization, vector quantization, or any combination thereof.

As described above, the processor 110 of the vehicle control apparatus 100 according to an example may perform operations described later by sampling the plurality of third points included in the third cluster, thereby reducing the amount of computation of the processor 110.

For example, the processor 110 may sample the plurality of third points at a specified interval (e.g., approximately 1 m). The processor 110 may obtain a plurality of fourth points by sampling the plurality of third points at a specified interval. For example, the processor 110 may obtain the plurality of fourth points of the specified number (e.g., about 100) by sampling the plurality of third points at a specified interval.

In an example, the processor 110 may store each of the plurality of fourth points thus obtained in a specified area of a memory. For example, the specified area of the memory may be referred to as a “buffer”. For example, the processor 110 may store each of the plurality of fourth points in a separate space within the buffer. For example, the processor 110 may store the plurality of fourth points in a first buffer.

In an example, the processor 110 may identify second virtual boxes corresponding to external objects identified as being of a specified type at a second time point after a first time point. The processor 110 may identify a plurality of fifth points included in the second virtual boxes. The processor 110 may store the plurality of fifth points included in the second virtual boxes in the specified area of the memory. For example, the processor 110 may store the plurality of fifth points in a second buffer.

In an example, the processor 110 may correct the plurality of fifth points based at least one of the plurality of fourth points obtained by sampling the plurality of third points at a specified interval, the plurality of fifth points included in the second virtual boxes corresponding to external objects identified as being of a specified type at the second time point, or any combination thereof. For example, the processor 110 may correct the plurality of fifth points by using equations included in FIG. 3, which will be described later.

As described above, the processor 110 of the vehicle control apparatus 100 according to an example may determine that the second virtual boxes correspond to a road edge, by correcting the plurality of fifth points. The processor 110 may accurately determine whether the second virtual boxes correspond to a road edge, by correcting the plurality of fifth points. The processor 110 may quickly identify that the external object identified within a road edge is in a movement state, by accurately determining that the second virtual boxes correspond to the road edge.

FIG. 2 shows an example in which a vehicle control apparatus performs clustering, according to an example of the present disclosure.

A host vehicle 200 of FIG. 2 may include the vehicle control apparatus 100 of FIG. 1.

A processor of a vehicle control apparatus according to an example may identify objects surrounding the host vehicle 200 by using a LiDAR. While the host vehicle 200 is driving, the processor may identify external objects including a road edge. For example, the road edge may include at least one of a guardrail, a median strip, a protective fence, a handrail, a curb, or any combination thereof.

In an example, the processor may identify the type of each of the external objects. For example, the processor may identify that an external object is of a first type in which the external object is in a stationary state, a second type in which the external object is in a movement state, and a third type in which the external object is not in either a stationary state or a movement state. The processor may perform clustering on a plurality of points included in a virtual box corresponding to the external object, based on the type of the external object.

In an example, the processor may perform clustering on the plurality of points included in the external object based on the fact that the length of the external object is greater than or equal to a specified length and is identified as a stationary object. For example, the specified length may include approximately 10 meters (m). For example, the length of an external object may be identified based on the length of the virtual box corresponding to the external object. The length of the virtual box corresponding to the external object may include the length of the virtual box formed in the x-axis among the x-axis, y-axis, and z-axis.

In an example, the processor may identify virtual boxes corresponding to external objects. The processor may identify a plurality of points included in the virtual boxes.

For example, the plurality of points may be referred to as “free-space points”. For example, the free-space point may include a point corresponding to the shortest distance between the external object and the host vehicle 200 at each angle divided by 360 degrees.

For example, the processor may obtain virtual boxes at the first time point and may correct the virtual boxes, which are obtained at the first time point, to virtual boxes at the second time point after the first time point. For example, the first time point may refer to a (t−1)-th frame. For example, the second time point may refer to a t-th frame. For example, the first time point and second time point may refer to time points at which frames are obtained continuously.

For example, the processor may perform clustering on a plurality of points included in the virtual box based on identifying that the virtual box corresponding to the external object is of a specified type. For example, the processor 110 may convert a plurality of first points, which are included in virtual boxes corresponding to external objects identified as being of a specified type at a first time point, into a plurality of second points at a second time point after the first time point. The processor may perform clustering on the plurality of second points.

In an example, the processor may generate a plurality of clusters 211, 213, and 215 based on performing clustering on the plurality of second points.

The processor may assign an identifier to each of the plurality of clusters 211, 213, and 215 based on generating the plurality of clusters 211, 213, and 215. For example, the identifier may be referred to as an “index”. For example, the processor may sequentially assign identifiers to the plurality of clusters 211, 213, and 215, respectively. For example, the processor may scan the host vehicle 200 clockwise from the front left of the host vehicle 200 and may sequentially assign identifiers to clusters starting from the identified cluster.

For example, the processor may assign a first identifier to the first cluster 211. For example, the processor may assign a second identifier to the second cluster 213. For example, the processor may assign a third identifier to the third cluster 215. For convenience of description, the assigning of identifiers to three clusters is described. However, an example is not limited thereto.

In an example, the processor may obtain slope information based on the minimum value and the maximum value of each of the plurality of clusters 211, 213, and 215. For example, the slope information may include heading information of each of the plurality of clusters 211, 213, and 215.

For example, the processor may obtain a first slope based on the first minimum value and the first maximum value included in the first cluster 211. For example, the processor may obtain the first slope by using the x-coordinate and y-coordinate of the first minimum value and the x-coordinate and y-coordinate of the first maximum value.

For example, the processor may obtain a second slope based on the second minimum value and the second maximum value included in the second cluster 213. For example, the processor may obtain the second slope by using the x-coordinate and y-coordinate of the second minimum value and the x-coordinate and y-coordinate of the second maximum value.

For example, the processor may obtain a third slope based on the third minimum value and the third maximum value included in the third cluster 215. For example, the processor may obtain the third slope by using the x-coordinate and y-coordinate of the third minimum value and the x-coordinate and y-coordinate of the third maximum value.

In an example, the processor may merge some of the plurality of clusters 211, 213, and 215 based on the slope information obtained by the plurality of clusters 211, 213, and 215.

In an example, the processor may merge some of the plurality of clusters 211, 213, and 215 based on a distance between the plurality of clusters 211, 213, and 215. For example, the processor may obtain distance information based on the plurality of clusters 211, 213, and 215. For example, the processor may obtain the distance information based on at least one of the minimum value, maximum value, or any combination thereof included in each of the plurality of clusters 211, 213, and 215.

For example, the distance information may include the distance between the minimum value and maximum value included in each of the plurality of clusters 211, 213, and 215. For example, the processor may identify the first minimum value and first maximum value of the first cluster 211. For example, the processor may identify the second minimum value and second maximum value of the second cluster 213. For example, the processor may identify the third minimum value and third maximum value of the third cluster 215. For example, the minimum value and maximum value may be identified based on at least one of the x-coordinate, y-coordinate, or any combination of each of a plurality of points included in each cluster. Alternatively or additionally, the processor may identify the minimum value and maximum value among a plurality of points included in each cluster based on the x-coordinates of each of the plurality of points included in each cluster.

For example, the processor may identify the first minimum value and first maximum value of the first cluster 211, and may identify the second minimum value and second maximum value of the second cluster 213. The processor may identify a distance between the first maximum value of the first cluster 211 and the second minimum value of the second cluster 213. The processor may create a third cluster 220, which is obtained by merging the first cluster 211 and the second cluster 213, based on the fact that the distance between the first maximum value of the first cluster 211 and the second minimum value of the second cluster 213 is smaller than or equal to a specified distance. For example, the specified distance may include approximately 5 m. However, an example is not limited thereto.

In an example, the processor may identify a plurality of third points included in the third cluster 220, based on generating the third cluster 220. The processor may sample a plurality of third points included in the third cluster 220 at a specified interval. For example, the specified interval may include approximately 1 m. The processor may obtain a plurality of fourth points based on sampling a plurality of third points included in the third cluster 220 at a specified interval.

In an example, the processor may store each of the plurality of fourth points in a specified area of a memory. For example, the specified area of the memory may be referred to as a “buffer”.

In an example, the processor may identify a plurality of fifth points included in virtual boxes identified at a second time point after the first time point. For example, the first time point may refer to a (t−1)-th frame. For example, the second time point may refer to a t-th frame. The processor may store each of the plurality of five points, which are included in the virtual boxes identified at the second time point, in the specified area of the memory.

For example, the processor may store each of the plurality of fourth points in a first buffer and may store each of the plurality of fifth points in a second buffer. The processor may compare the plurality of fourth points stored in the first buffer with the plurality of fifth points stored in the second buffer, respectively.

For example, the processor may identify distances between the plurality of fourth points and the plurality of fifth points respectively corresponding to the plurality of fourth points. The processor may obtain an average of the obtained distances based on obtaining the distances between the plurality of fourth points and the plurality of fifth points respectively corresponding to the plurality of fourth points.

The processor may correct the plurality of fifth points obtained at the second time point, based on the obtained average. For example, the processor may correct the plurality of fifth points, which are obtained at the second time point, by moving the plurality of fifth points by the obtained average.

The correcting of the point at a past time point to a point at a current time point will be described below.

In an example, the processor may correct a plurality of points, which are obtained at the first time point, to a plurality of points obtained at the second time point based on information related to the driving of the host vehicle. For example, the information related to the driving of the host vehicle may include at least one of the speed of the host vehicle, the steering angle of the host vehicle, the yaw rate, or any combination thereof.

For example, the processor may identify a yaw angle of the host vehicle, based on Equation 1.

$$θ = Yawrate * Delta \qquad [ Equation 1 ]$$

In Equation 1, θ may include a yaw angle of the host vehicle. In Equation 1, Yawrate may include a yaw rate of the host vehicle. In Equation 1, Delta may include a period at which sensor data is received. For example, the period at which the sensor data is received may include a period at which data sets are obtained by a LiDAR.

For example, the processor may correct x coordinate based on Equation 2.

$${x}_{dist} = {V}_{x} * Delta \qquad [ Equation 2 ]$$

In Equation 2, x_{dist} may include the corrected x

coordinate. In Equation 2, Vₓ may include a speed of the host vehicle 200 in an x-axis direction. In Equation 2, Delta may include a period at which sensor data is received.

For example, the processor may correct a y coordinate based on Equation 3.

$${y}_{dist} = {V}_{y} * Delta \qquad [ Equation 3 ]$$

In Equation 3, y_{dist} may include the corrected y coordinate. In Equation 3, V_{y} may include a speed of the host vehicle 200 in a y-axis direction. In Equation 2, Delta may include a period at which sensor data is received.

In an example, the processor may correct a plurality of points, which are obtained at a past time point, to a plurality of points at a current time point based on at least one of Equation 1, Equation 2, Equation 3, or any combination thereof. For example, the processor may correct the plurality of points, which are obtained at the past time point, to the plurality of points at the current time point based on Equation 4.

$$Tv = [ \begin{matrix}{x}_{dist} \\ {y}_{dist}\end{matrix} ] + [ \begin{matrix}x \\ y\end{matrix} ] = [ \begin{matrix}x + {x}_{dist} \\ y + {y}_{dist}\end{matrix} ] \qquad [ Equation 4 ]$$

In Equation 4, Tν may include a function (or matrix) for correcting a point, which is obtained at the past time point, to a point at the current time point. In Equation 4,

$$[ \begin{matrix}x \\ y\end{matrix} ]$$

may include the x-coordinate and y-coordinate of the point obtained at the past time point. For example, the processor may obtain x_{dist} by using Equation 2, may obtain y_{dist} by using Equation 3, may apply the obtained x_{dist} and y_{dist} to Equation 4, and may correct the coordinates of the point, which is obtained at the past time point, to coordinates of the point at the current time point.

In an example, the processor may perform location correction on an angle. For example, the processor may perform location correction on an angle by using Equation 5.

$$Rv = [ \begin{matrix}cos θ & - sin θ \\ sin θ & cos θ\end{matrix} ] [ \begin{matrix}x \\ y\end{matrix} ] = [ \begin{matrix}x cos θ & y sin θ \\ x sin θ & y cos θ\end{matrix} ] \qquad [ Equation 5 ]$$

For example, in Equation 5, Rν may include a function (or matrix) to correct the angle of the point obtained at the past time point. For example, the processor may correct the angle of a point obtained at the past time point by applying θ, which is obtained by using Equation 1, to Equation 5.

Hereinafter, the identifying of the location of the cluster based on the host vehicle will be described with reference to FIG. 3.

FIG. 3 shows an example in which a vehicle control apparatus identifies a road edge, according to an example of the present disclosure.

A host vehicle 300 of FIG. 3 may include the vehicle control apparatus 100 of FIG. 1.

Referring to FIG. 3, a processor of a vehicle control apparatus according to an example may predict a movement route 320 of a host vehicle 300. For example, the processor may predict the movement route 320 based on at least one of the speed of the host vehicle 300, the yaw rate of the host vehicle 300, the steering angle of the host vehicle 300, or any combination thereof.

In an example, the processor may identify a direction in which a third cluster 310 is located relative to the host vehicle 300.

For example, the processor may identify a direction, in which the third cluster 310 is located relative to the host vehicle 300, by using parameters different depending on the speed of the host vehicle 300. For example, if the host vehicle 300 is driven at the speed of the first section, the processor may identify the direction, in which the third cluster 310 is located relative to the host vehicle 300, based on at least one of the wheel space of the host vehicle 300, the steering angle of the host vehicle 300, the speed of the host vehicle 300, the yaw rate of the host vehicle 300, or any combination thereof. For example, the first section may include a section having a speed range between approximately 2.0 m/s and approximately 4.0 m/s. For example, a case where the host vehicle 300 is driven at the speed of the first section may include a case where the host vehicle 300 is driven at a low speed.

For example, if the speed of the host vehicle 300 exceeds the speed of the first section, the processor may identify a direction, in which the third cluster 310 is located relative to the host vehicle 300, based on at least one of the yaw rate of the host vehicle 300, the speed of the host vehicle 300, or any combination thereof. For example, a case where the host vehicle 300 is driven at a speed exceeding the speed of the first section may include a case where the host vehicle 300 is driven in a high-speed situation.

If the host vehicle 300 is driven at the speed of the first section, the processor may obtain the radius of curvature by using equations below.

$${V}_{lat} ≅ V * tan ( δ ) \qquad [ Equation 6 ]$$

For example, in Equation 6, V may include a speed of the host vehicle 300. In Equation 6, δ may include a steering angle of the host vehicle 300. The processor may obtain Vₗₐₜ indicating a lateral speed of the host vehicle 300 based on the speed of the host vehicle 300 and the steering angle of the host vehicle 300.

$${φ}_{slow} = \frac{V * tan ( δ )}{L} ≅ \frac{{V}_{lat}}{L} \qquad [ Equation 7 ]$$

For example, in Equation 7, L may include a wheel space of the host vehicle 300. The processor may obtain φ_{slow} indicating the yaw rate at a low speed based on the speed of the host vehicle 300, the steering angle of the host vehicle 300, or the wheel space of the host vehicle 300.

$$\overline{φ} = ( ( 1 - α ) * {φ}_{slow} ) + ( α * φ ) \qquad [ Equation 8 ]$$

For example, in Equation 8, α may be an engineer coefficient and may include a constant between 0 and 1. For example, in Equation 8, φ_{slow} may include a value obtained by using Equation 7. For example, in Equation 8, φ may include a yaw rate of the host vehicle 300. The processor may obtain φ̅ indicating an average of yaw rates by using the yaw rate of the host vehicle 300 and the yaw rate at a low speed.

$$Radius = \frac{V}{\overline{φ}} \qquad [ Equation 9 ]$$

In an example, the processor may obtain the radius of curvature by using Equation 9. For example, in Equation 9, V may include a speed of the host vehicle 300. For example, the processor may obtain Radius indicating the radius of curvature based on φ̅ obtained by using Equation 8 and the speed of the host vehicle 300.

In an example, the processor may obtain the radius of curvature by using Equation 10 below if the host vehicle 300 is driven at a speed exceeding a speed of the first section. For example, the processor may obtain the radius of curvature by using Equation 10 if the host vehicle 300 is driving at a high speed.

$$Radius = \frac{V}{φ} \qquad [ Equation 10 ]$$

For example, in Equation 10, V may include a speed of

the host vehicle 300. For example, in Equation 10, φ may include a yaw rate of the host vehicle 300. For example, the processor may obtain the radius of curvature at a high speed based on the speed of the host vehicle 300 and the yaw rate of the host vehicle 300.

As described above, the processor may obtain the radius of curvature of the host vehicle 300 by using at least one of Equation 9, Equation 10, or any combination thereof.

The processor may identify a direction, in which the third cluster 310 is located relative to the host vehicle 300, based on the radius of curvature of the host vehicle 300.

For example, when the radius of curvature of the host vehicle 300 obtained by using at least one of Equation 9, Equation 10, or any combination thereof is a positive number, the processor may identify a lateral location of the third cluster 310 based on the radius of curvature of the host vehicle 300 by using Equation 11.

$${R}_{lat} = - Radius + \sqrt{{( Radius + y )}^{2} + {x}^{2}} \qquad [ Equation 11 ]$$

For example, when the radius of curvature of the host vehicle 300 obtained by using at least one of Equation 9, Equation 10, or any combination thereof is a negative number, the processor may identify the lateral location of the third cluster 310 based on the radius of curvature of the host vehicle 300 by using Equation 12.

$${R}_{lat} = - Radius - \sqrt{{( Radius + y )}^{2} + {x}^{2}} \qquad [ Equation 12 ]$$

For example, in Equation 11 and Equation 12, x and y may include the x-coordinate and y-coordinate of a point, respectively. For example, Rₗₐₜ obtained from Equation 11 and Equation 12 may include a distance 330 at which the third cluster 310 is spaced from the movement route 320 of the host vehicle 300. In an example, the processor may identify the location of the cluster based on Rₗₐₜ obtained by using Equation 12.

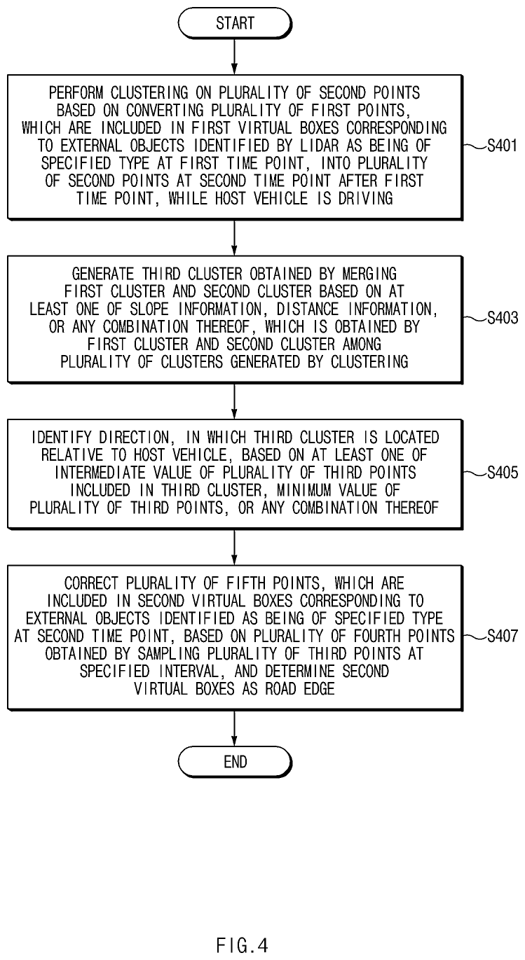

FIG. 4 shows an example of a flowchart related to a vehicle control method, according to an example of the present disclosure.

Hereinafter, it is assumed that the vehicle controlling apparatus 100 of FIG. 1 performs the process of FIG. 4. In addition or alternative, in a description of FIG. 4, it may be understood that an operation described as being performed by an apparatus is controlled by the processor 110 of the vehicle control apparatus 100.

At least one of operations of FIG. 4 may be performed by the vehicle control apparatus 100 of FIG. 1. Each of the operations in FIG. 4 may be performed sequentially, but is not necessarily sequentially performed. For example, the order of operations may be changed, and at least two operations may be performed in parallel.

Referring to FIG. 4, in operation S401, a vehicle control method according to an example may include an operation of performing clustering on a plurality of second points based on converting a plurality of first points, which are included in first virtual boxes corresponding to external objects identified by the LiDAR as being of a specified type at a first time point, into a plurality of second points at a second time point after the first time point, while the host vehicle is driving.

For example, the vehicle control method may include an operation of converting a plurality of first points, which are identified at the first time point by using the equations described in FIG. 2, into a plurality of second points at a second time point after the first time point.

In operation S403, the vehicle control method according to an example may include an operation of generating a third cluster obtained by merging the first cluster and the second cluster based on at least one of slope information, distance information, or any combination thereof, which is obtained by the first cluster and the second cluster among a plurality of clusters generated by clustering.

For example, the vehicle control method may include an operation of generating a third cluster, which is obtained by merging the first cluster and the second cluster, based on at least one of a first slope by the first minimum value and first maximum value included in the first cluster, a second slope by the second minimum value and second maximum value included in the second cluster, or any combination thereof.

For example, the vehicle control method may include an operation of obtaining distance information based on at least one of a distance between the first minimum value and the second maximum value, a distance between the second minimum value and the first maximum value, or any combination thereof.

For example, the vehicle control method may include an operation of generating the third cluster, which is obtained by merging the first cluster and the second cluster, based on the fact that at least one of the distance between the first minimum value and the second maximum value, the distance between the second minimum value and the first maximum value, or any combination thereof is smaller than or equal to the specified distance.

in operation S405, the vehicle control method according to an example may include an operation of identifying a direction, in which the third cluster is located relative to the host vehicle, based on at least one of the intermediate value of a plurality of third points included in the third cluster, the minimum value of the plurality of third points, or any combination thereof.

For example, the vehicle control method may include an operation of identifying the direction, in which the third cluster is located relative to the host vehicle, based on the radius of curvature based on the host vehicle and the plurality of third points.

In operation S407, the vehicle control method according to an example may include an operation of correcting a plurality of fifth points, which are included in second virtual boxes corresponding to external objects identified as being of a specified type at the second time point, based on a plurality of fourth points obtained by sampling a plurality of third points at a specified interval, and determining the second virtual boxes as a road edge.

As described above, the vehicle control method according to an example may include an operation of accurately identifying that the second virtual boxes correspond to a road edge, by correcting the plurality of fifth points included in the second virtual boxes.

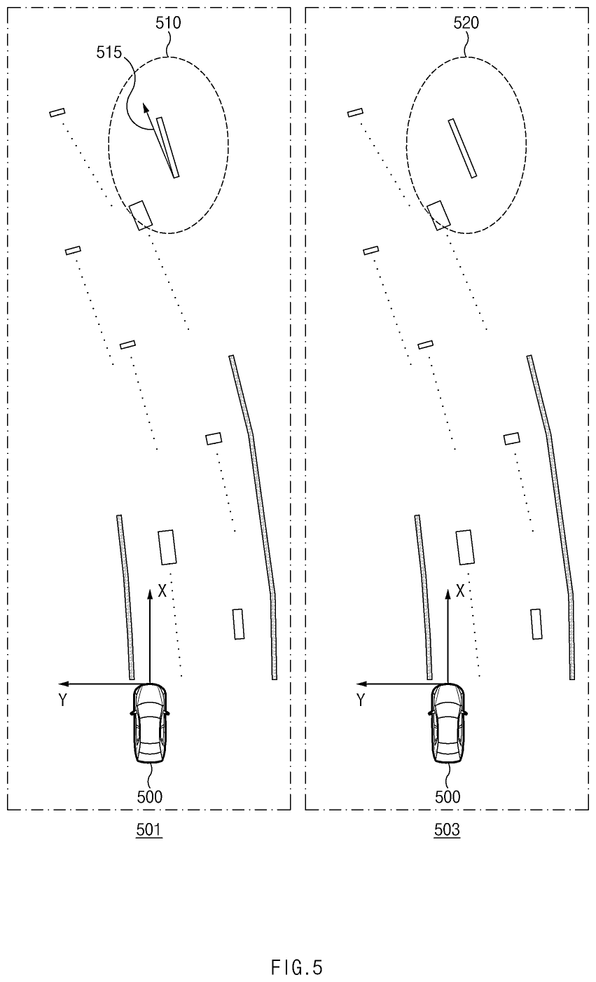

FIG. 5 shows an example of the result obtained as a vehicle control apparatus corrects a plurality of points, according to an example of the present disclosure.

A host vehicle 500 of FIG. 5 may include the vehicle control apparatus 100 of FIG. 1.

Referring to FIG. 5, a first example 501 may include an example of identifying an external object without correcting a plurality of points.

For example, in the first example 501, the processor may identify that a virtual box 510 corresponding to the external object is a moving object. For example, the moving object may include an object that has a speed and directivity as the external object moves. For example, the processor may identify a heading direction 515 of the virtual box 510 by identifying the virtual box 510 corresponding to the external object as a moving object.

A second example 503 may include an example in which a virtual box 520 corresponding to an external object is determined to be a road edge when the present technology is applied.

For example, because an external object is occluded by another external object even though it is identified that the road edge is divided, the processor of the vehicle control apparatus may determine that the external object that present on the extension line of a curved road is a road edge, by applying the present technology.

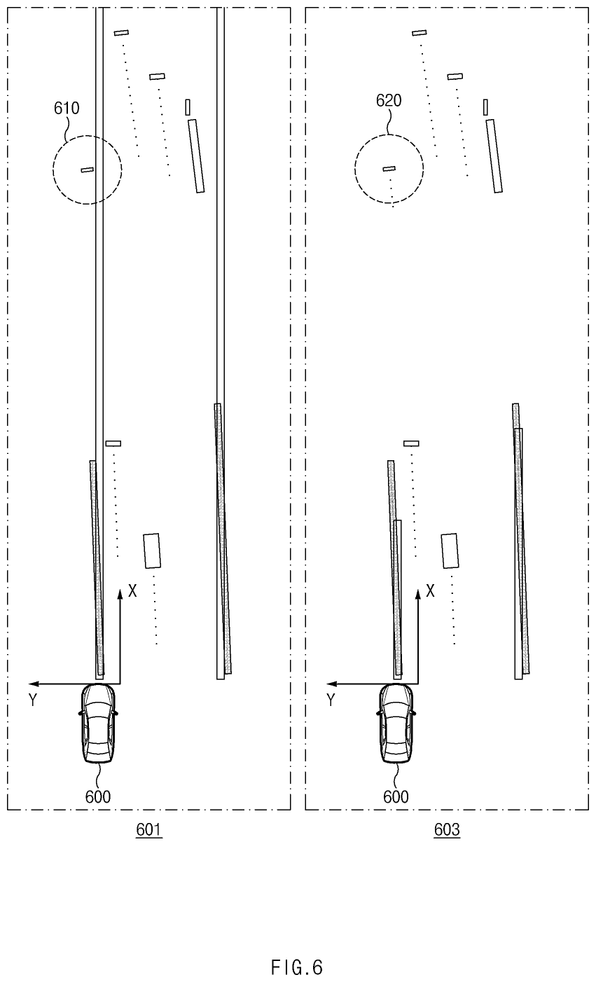

FIG. 6 shows an example of the result obtained as a vehicle control apparatus corrects a plurality of points, according to an example of the present disclosure.

A host vehicle 600 of FIG. 6 may include the vehicle control apparatus 100 of FIG. 1.

Referring to FIG. 6, a third example 601 may include an example in which, because it is determined that a road edge is a straight line even though a host vehicle 600 is driving on a curved road, it is identified that a virtual box 610 corresponding to a preceding vehicle is off the road, and thus the virtual box 610 is identified as a stationary object. For example, the preceding vehicle may be referred to as “closest in path vehicle (CIPV)”.

A fourth example 603 may include an example of applying the present technology. For example, a processor of a vehicle control apparatus may accurately identify a curved road by applying the present technology, and thus may identify that a virtual box 620 corresponding to an external object is located inside the road. The processor may relatively quickly identify that the type of the virtual box 620 corresponds to a movement state, based on the virtual box 620 being placed inside the road.

The processor may determine that the road on which the host vehicle 600 is driving is a curved road, by applying the present technology, and thus may relatively quickly identify that the external object identified within the curved road is a preceding vehicle.

The processor may identify that the external object within the curved road is the preceding vehicle, and may identify that the preceding vehicle is in a movement state, thereby providing assistance in driving the host vehicle 600.

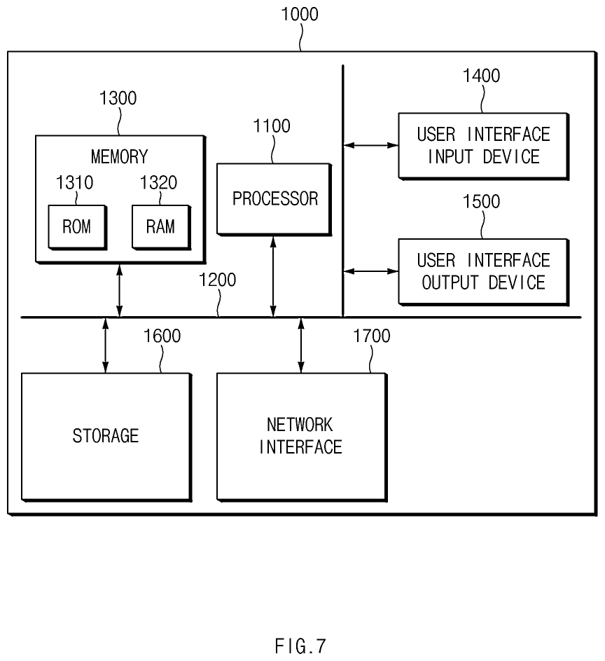

FIG. 7 shows an example of a computing system including a vehicle control apparatus, according to an example of the present disclosure.

Referring to FIG. 7, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively or additionally, the storage medium may be integrated with the processor 1100. The processor and storage medium may be implemented with an application specific integrated circuit (ASIC). The ASIC may be provided in a user terminal. Alternatively or additionally, the processor and storage medium may be implemented with separate components in the user terminal.

The above description is merely an example of the technical idea of the present disclosure, and various modifications and modifications may be made by one skilled in the art without departing from the essential characteristic of the present disclosure.

The present disclosure has been made to solve the above-mentioned problems occurring in the prior art while advantages achieved by the prior art are maintained intact.

An example of the present disclosure provides a vehicle control apparatus for determining a road edge at a current time by using points identified at a past time point, and a method thereof.

An example of the present disclosure provides a vehicle control apparatus for reducing the load of a processor by performing operations through the sampling of a plurality of points, and a method thereof.

An example of the present disclosure provides a vehicle control apparatus for quickly determining that an external object identified within the road edge is a moving object, by accurately determining the road edge, and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus may include a processor and a light detection and ranging (LiDAR). In an example, the processor may perform clustering on a plurality of second points based on converting a plurality of first points, which are included in first virtual boxes corresponding to external objects identified by the LiDAR as being of a specified type at a first time point, into the plurality of second points at a second time point after the first time point, while a host vehicle is driving, may generate a third cluster obtained by merging a first cluster and a second cluster based on at least one of slope information, distance information, or a combination of the slope information and the distance information, which is obtained by the first cluster and the second cluster among a plurality of clusters generated by clustering, may identify a direction, in which the third cluster is located relative to the host vehicle, based on at least one of an intermediate value of a plurality of third points included in the third cluster, a minimum value of the plurality of third points, or a combination of the intermediate value and the minimum value, and may correct a plurality of fifth points based at least one of a plurality of fourth points obtained by sampling the plurality of third points at a specified interval, the plurality of fifth points included in second virtual boxes corresponding to the external objects identified as being of the specified type at the second time point, or a combination of the plurality of fourth points and the plurality of fifth points, and determine the second virtual boxes as a road edge.

In an example, the processor may obtain the slope information based on at least one of a first slope by a first minimum value and a first maximum value, which are included in the first cluster, a second slope by a second minimum value and a second maximum value, which are included in the second cluster, or a combination of the first slope and the second slope, and may generate the third cluster, which is obtained by merging the first cluster and the second cluster, based on an angle between the first slope and the second slope being smaller than or equal to a specified angle.

In an example, the processor may obtain the distance information based on at least one of a distance between the first minimum value and the second maximum value, a distance between the second minimum value and the first maximum value, or a combination of the distance between the first minimum value and the second maximum value, and the distance between the second minimum value and the first maximum value, and may generate the third cluster, which is obtained by merging the first cluster and the second cluster, based on at least one of the distance between the first minimum value and the second maximum value, the distance between the second minimum value and the first maximum value, or the combination of the distance between the first minimum value and the second maximum value, and the distance between the second minimum value and the first maximum value being smaller than or equal to a specified distance.

In an example, the specified type may include a first type among the first type in which the external object is in a stationary state, a second type in which the external object is in a movement state, and a third type in which the external object is not in either the stationary state or the movement state.

In an example, the processor may identify a direction, in which the third cluster is located relative to the host vehicle, based on at least one of a wheel space of the host vehicle, a steering angle of the host vehicle, a speed of the host vehicle, a yaw rate of the host vehicle, or a combination of the wheel space, the steering angle, the speed, and the yaw rate, if the host vehicle is driven at a speed of a first section, and may identify a direction, in which the third cluster is located relative to the host vehicle, based on at least one of the yaw rate of the host vehicle, the speed of the host vehicle, or a combination of the yaw rate and the speed, if the host vehicle is driven at a speed exceeding the speed of the first section.

In an example, the processor may identify differences between the plurality of fourth points stored in a first region and the plurality of fifth points, which are stored in a second region and which respectively correspond to the plurality of fourth points, and may correct each of the plurality of five points based on an average of the identified differences.

In an example, the processor may convert the plurality of first points identified at the first time point to the plurality of second points at the second time point based on information related to driving of the host vehicle.

In an example, the information related to the driving of the host vehicle may include at least one of a speed of the host vehicle, a yaw rate of the host vehicle, a time interval at which a plurality of points are obtained by the LiDAR, or a combination of the speed, the yaw rate, and the time interval.

In an example, the processor may generate the third cluster, which is obtained by merging the first cluster and the second cluster, based on the first cluster including a plurality of points of which a number is greater than or equal to a reference number, and the second cluster including a plurality of points of which a number is greater than or equal to the reference number.

In an example, the processor may generate the third cluster, which is obtained by merging the first cluster and the second cluster, based on a length of the first cluster being greater than or equal to a reference length, and a length of the second cluster being greater than or equal to the reference length.

In an example, the processor may generate the third cluster, which is obtained by merging the first cluster and the second cluster, based on identifying that the first cluster and the second cluster are within a reference distance based on a lateral direction of the host vehicle.

According to an example of the present disclosure, a vehicle control method may include performing clustering on a plurality of second points based on converting a plurality of included in first virtual boxes first points, which are corresponding to external objects identified by a LiDAR as being of a specified type at a first time point, into the plurality of second points at a second time point after the first time point, while a host vehicle is driving, generating a third cluster obtained by merging a first cluster and a second cluster based on at least one of slope information, distance information, or a combination of the slope information and the distance information, which is obtained by the first cluster and the second cluster among a plurality of clusters generated by clustering, identifying a direction, in which the third cluster is located relative to the host vehicle, based on at least one of an intermediate value of a plurality of third points included in the third cluster, a minimum value of the plurality of third points, or a combination of the intermediate value and the minimum value, and correcting a plurality of fifth points based at least one of a plurality of fourth points obtained by sampling the plurality of third points at a specified interval, the plurality of fifth points included in second virtual boxes corresponding to the external objects identified as being of the specified type at the second time point, or a combination of the plurality of fourth points and the plurality of fifth points, and determining the second virtual boxes as a road edge.

According to an example, the vehicle control method may further include obtaining the slope information based on at least one of a first slope by a first minimum value and a first maximum value, which are included in the first cluster, a second slope by a second minimum value and a second maximum value, which are included in the second cluster, or a combination of the first slope and the second slope, and generating the third cluster, which is obtained by merging the first cluster and the second cluster, based on an angle between the first slope and the second slope being smaller than or equal to a specified angle.

According to an example, the vehicle control method may further include obtaining the distance information based on at least one of a distance between the first minimum value and the second maximum value, a distance between the second minimum value and the first maximum value, or a combination of the distance between the first minimum value and the second maximum value, and the distance between the second minimum value and the first maximum value, and generating the third cluster, which is obtained by merging the first cluster and the second cluster, based on at least one of the distance between the first minimum value and the second maximum value, the distance between the second minimum value and the first maximum value, or the combination of the distance between the first minimum value and the second maximum value, and the distance between the second minimum value and the first maximum value being smaller than or equal to a specified distance.

In an example, the specified type may include a first type among the first type in which the external object is in a stationary state, a second type in which the external object is in a movement state, and a third type in which the external object is not in either the stationary state or the movement state.

According to an example, the vehicle control method may further include identifying a direction, in which the third cluster is located relative to the host vehicle, based on at least one of a wheel space of the host vehicle, a steering angle of the host vehicle, a speed of the host vehicle, a yaw rate of the host vehicle, or a combination of the wheel space, the steering angle, the speed, and the yaw rate, if the host vehicle is driven at a speed of a first section, and identifying a direction, in which the third cluster is located relative to the host vehicle, based on at least one of the yaw rate of the host vehicle, the speed of the host vehicle, or a combination of the yaw rate and the speed, if the host vehicle is driven at a speed exceeding the speed of the first section.

According to an example, the vehicle control method may further include identifying differences between the plurality of fourth points stored in a first region and the plurality of fifth points, which are stored in a second region and which respectively correspond to the plurality of fourth points, and correcting each of the plurality of five points based on an average of the identified differences.

According to an example, the vehicle control method may further include converting the plurality of first points identified at the first time point to the plurality of second points at the second time point based on information related to driving of the host vehicle.

In an example, the information related to the driving of the host vehicle may include at least one of a speed of the host vehicle, a yaw rate of the host vehicle, a time interval at which a plurality of points are obtained by the LiDAR, or a combination of the speed, the yaw rate, and the time interval. According to an example, the vehicle control method may further include generating the third cluster, which is obtained by merging the first cluster and the second cluster, based on the first cluster including a plurality of points of which a number is greater than or equal to a reference number, and the second cluster including a plurality of points of which a number is greater than or equal to the reference number.

Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

According to an example of the present disclosure, a vehicle control apparatus may determine a road edge at a current time by using points identified at a past time point.

According to an example of the present disclosure, a vehicle control apparatus may reduce the load of a processor by performing operations through the sampling of a plurality of points.

According to an example of the present disclosure, a vehicle control apparatus may quickly determine that an external object identified within the road edge is a moving object, by accurately determining the road edge.

Besides, a variety of effects directly or indirectly understood through the specification may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling a vehicle, the apparatus comprising:
a processor; and
a sensor;
wherein the processor is configured to:
at a first time point, determine first virtual boxes corresponding to objects detected by the sensor, wherein the objects are external to the vehicle, and the first virtual boxes comprise a plurality of first points;
at a second time point after the first time point, convert the plurality of first points into a plurality of second points while the vehicle is driving and determine second virtual boxes corresponding to the objects detected at the second time point, wherein the second virtual boxes comprise a plurality of fifth points;
perform, based on the converting, clustering on the plurality of second points to generate a plurality of clusters comprising a first cluster and a second cluster;
generate a third cluster obtained by merging the first cluster and the second cluster based on at least one of slope information or distance information which is obtained by the first cluster and the second cluster;
determine a direction, in which the third cluster is located relative to the vehicle, based on at least one of:
an intermediate value of a plurality of third points included in the third cluster, or
a minimum value of the plurality of third points;
adjust the plurality of fifth points based on a plurality of fourth points obtained by sampling the plurality of third points at an interval;
determine, based on the adjusted plurality of fifth points, the second virtual boxes as a road edge; and
output, based on the road edge, a signal to control the vehicle.

2. The apparatus of claim 1, wherein the processor is configured to generate the third cluster by:
obtaining the slope information based on at least one of:
a first slope by a first minimum value and a first maximum value, which are included in the first cluster, or
a second slope by a second minimum value and a second maximum value, which are included in the second cluster;
merging the first cluster and the second cluster based on an angle between the first slope and the second slope, wherein the second slope is smaller than or equal to a threshold angle.

3. The apparatus of claim 2, wherein the processor is configured to generate the third cluster by:
obtaining the distance information based on at least one of:
a distance between the first minimum value and the second maximum value, or
a distance between the second minimum value and the first maximum value;
merging the first cluster and the second cluster, based on at least one of:
the distance between the first minimum value and the second maximum value, or
the distance between the second minimum value and the first maximum value, wherein the first maximum value is smaller than or equal to a specified distance.

4. The apparatus of claim 1, wherein a type of the objects specified at the first time point comprises:
a first type in which the objects are in a stationary state,
a second type in which the objects are in a movement state, and
a third type in which the objects are not in either the stationary state or the movement state.

5. The apparatus of claim 1, wherein the vehicle is driven at a speed of a first section, the processor is configured to:
determine the direction, in which the third cluster is located relative to the vehicle, based on at least one of:
a wheel space of the vehicle,
a steering angle of the vehicle,
a speed of the vehicle, or
a yaw rate of the vehicle; and
wherein the vehicle is driven at a speed exceeding the speed of the first section, the processor is configured to:
determine the direction, in which the third cluster is located relative to the vehicle, based on at least one of:
the yaw rate of the vehicle, or
the speed of the vehicle.

6. The apparatus of claim 1, wherein the processor is configured to:
determine differences between the plurality of fourth points stored in a first region and the plurality of fifth points, which are stored in a second region and which respectively correspond to the plurality of fourth points; and
adjust each of the plurality of fifth points based on an average of the determined differences.

7. The apparatus of claim 1, wherein the processor is configured to:
convert the plurality of first points, determined at the first time point, to the plurality of second points at the second time point based on information related to driving of the vehicle.

8. The apparatus of claim 7, wherein the information related to the driving of the vehicle includes at least one of:
a speed of the vehicle,
a yaw rate of the vehicle, or
a time interval at which a plurality of points are obtained by the sensor.

9. The apparatus of claim 1, wherein the processor is configured to generate the third cluster by merging the first cluster and the second cluster, based on:
the first cluster including a plurality of points of which a number is greater than or equal to a reference number, and
the second cluster including a plurality of points of which a number is greater than or equal to the reference number.

10. The apparatus of claim 1, wherein the processor is configured to generate the third cluster by merging the first cluster and the second cluster, based on:
a length of the first cluster being greater than or equal to a reference length, and
a length of the second cluster being greater than or equal to the reference length.

11. The apparatus of claim 1, wherein the processor is configured to generate the third cluster by merging the first cluster and the second cluster, based on determining that the first cluster and the second cluster are within a reference distance based on a lateral direction of the vehicle.

12. A method for controlling a vehicle, the method comprising:
at a first time point, determining first virtual boxes corresponding to objects detected by a sensor, wherein the objects are external to the vehicle, and the first virtual boxes comprise a plurality of first points;
at a second time point after the first time point, converting the plurality of first points into a plurality of second points while the vehicle is driving and determining second virtual boxes corresponding to the objects detected at the second time point, wherein the second virtual boxes comprise a plurality of fifth points;
performing, based on the converting, clustering on the plurality of second points to generate a plurality of clusters comprising a first cluster and a second cluster;
generating a third cluster obtained by merging the first cluster and the second cluster based on at least one of slope information or distance information, which is obtained by the first cluster and the second cluster;
determining a direction, in which the third cluster is located relative to the vehicle, based on at least one of:
an intermediate value of a plurality of third points included in the third cluster, or
a minimum value of the plurality of third points;
adjusting a plurality of fifth points based on a plurality of fourth points obtained by sampling the plurality of third points at an interval;
determining, based on the adjusting, the second virtual boxes as a road edge; and
outputting, based on the road edge, a signal to control the vehicle.

13. The method of claim 12, wherein the generating the third cluster comprises:
obtaining the slope information based on at least one of:
a first slope by a first minimum value and a first maximum value, which are included in the first cluster, or
a second slope by a second minimum value and a second maximum value, which are included in the second cluster;
merging the first cluster and the second cluster, based on an angle between the first slope and the second slope, wherein the second slope is smaller than or equal to a specified angle.

14. The method of claim 13, wherein the generating the third cluster comprises:
obtaining the distance information based on at least one of:
a distance between the first minimum value and the second maximum value, or
a distance between the second minimum value and the first maximum value;
merging the first cluster and the second cluster, based on at least one of:
the distance between the first minimum value and the second maximum value, or
the distance between the second minimum value and the first maximum value, wherein the first maximum value is smaller than or equal to a threshold distance.

15. The method of claim 12, wherein a type of the objects specified at the first time point comprises:
a first type in which the objects are in a stationary state,
a second type in which the objects are in a movement state, and
a third type in which the objects are not in either the stationary state or the movement state.

16. The method of claim 12, wherein the vehicle is driven at a speed of a first section, further comprising:
determining the direction, in which the third cluster is located relative to the vehicle, based on at least one of:
a wheel space of the vehicle,
a steering angle of the vehicle,
a speed of the vehicle, or
a yaw rate of the vehicle; and
wherein the vehicle is driven at a speed exceeding the speed of the first section, further comprising:
determining the direction, in which the third cluster is located relative to the vehicle, based on at least one of:
the yaw rate of the vehicle, or
the speed of the vehicle.

17. The method of claim 12, further comprising:
determining differences between the plurality of fourth points stored in a first region and the plurality of fifth points, which are stored in a second region and which respectively correspond to the plurality of fourth points; and
adjusting each of the plurality of fifth points based on an average of the determined differences.

18. The method of claim 12, wherein converting the plurality of first points is based on information related to driving of the vehicle.

19. The method of claim 18, wherein the information related to the driving of the vehicle includes at least one of:
a speed of the vehicle,
a yaw rate of the vehicle, or
a time interval at which a plurality of points are obtained by the sensor.

20. The method of claim 12, wherein the generating the third cluster comprises:
merging the first cluster and the second cluster, based on:
the first cluster including a plurality of points of which a number is greater than or equal to a reference number, and
the second cluster including a plurality of points of which a number is greater than or equal to the reference number.
